(19) United States
(12) Patent Application Publication
(10) Pub. No.: US 2026/0135098 A1
(43) Pub. Date: May 14, 2026

(54) Cathode for Lithium Secondary Battery and Lithium Secondary Battery Including the Same

(71) Applicant: SK On Co., Ltd., Seoul (KR)

(72) Inventors: Seong Cho Kwon, Daejeon (KR); Hwan Ho Jang, Daejeon (KR); Sang Won Park, Daejeon (KR)

(21) Appl. No.: 19/383,981

(22) Filed: Nov. 10, 2025

(30) Foreign Application Priority Data
Nov. 11, 2024 (KR) 10-2024-0159262

(51) Int. Cl. H01M 4/525; H01M 4/131; H01M 4/133; H01M 4/36; H01M 4/587; H01M 4/62; H01M 10/052

(52) U.S. Cl. CPC H01M 4/525; H01M 4/131; H01M 4/133; H01M 4/366; H01M 4/587; H01M 4/625; H01M 10/052

(57) ABSTRACT

A cathode for a lithium secondary battery includes a cathode current collector and sequentially stacked first and second cathode active material layers on one surface thereof. The first cathode active material layer includes a first conductive material and either a first cathode active material having a single-particle structure or a mixture of the first and a second cathode active material having a secondary-particle structure. The second cathode active material layer includes a second conductive material and either the second cathode active material or a mixture of the first and second cathode active materials. The content of the first cathode active material in the first cathode active material layer is greater than the content of the second cathode active material, while the content of the second cathode active material in the second cathode active material layer is greater than or equal to that of the first.

### CROSS-REFERENCE TO RELATED APPLICATION

This application claims priority to Korean Patent Application No. 10-2024-0159262 filed Nov. 11, 2024, the disclosure of which is hereby incorporated by reference in its entirety.

### BACKGROUND

### Technical Field

The present disclosure relates to a cathode for a lithium secondary battery and a lithium secondary battery comprising the cathode.

### Technical Considerations

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, a nickel-hydrogen battery and the like. Among them, the lithium secondary battery has a high operating voltage and a high energy density per unit weight, making it advantageous in terms of charging speed and weight reduction. In this regard, the lithium secondary battery has been actively developed and applied to various industrial fields.

The lithium secondary battery may include, for example, an electrode assembly including a cathode, an anode and a separation membrane interposed between the cathode and the anode, and an electrolyte that impregnates the electrode assembly.

The cathode may include a cathode current collector and a cathode active material layer formed on the cathode current collector. For example, the cathode active material layer may include a cathode active material, a conductive material, a binder and the like.

During repeated charging and discharging of the lithium secondary battery, the cathode may collapse due to the intercalation and deintercalation of lithium ions into and from the cathode active material. As a result, problems such as gas generation due to side reactions between the lithium metal oxide particles and the electrolyte, and degradation of the cycle life characteristics of the lithium secondary battery may occur. In addition, the above-described problems may be more pronounced during repeated fast charging and discharging.

### SUMMARY

A non-limiting object of the present disclosure is to provide a cathode for a lithium secondary battery having improved electrochemical properties.

Another non-limiting object of the present disclosure is to provide a lithium secondary battery comprising the cathode.

A cathode for a lithium secondary battery according to some non-limiting embodiments of the present disclosure comprises: a cathode current collector; and a first cathode active material layer and a second cathode active material layer sequentially stacked on one surface of the cathode current collector. The first cathode active material layer comprises a first conductive material and either a first cathode active material having a single-particle structure, or a mixture of the first cathode active material and a second cathode active material having a secondary-particle structure. The second cathode active material layer comprises a second conductive material and either the second cathode active material, or a mixture of the first cathode active material and the second cathode active material. In the first cathode active material layer, the content of the first cathode active material is greater than the content of the second cathode active material, based on the total weight of the first cathode active material layer. In the second cathode active material layer, the content of the second cathode active material is greater than or equal to the content of the first cathode active material, based on the total weight of the second cathode active material layer. The content of the first conductive material in the first cathode active material layer, based on the total weight of the first cathode active material layer, is greater than the content of the second conductive material in the second cathode active material layer, based on the total weight of the second cathode active material layer.

In some non-limiting embodiments, the content of the first cathode active material in the first cathode active material layer, based on the total weight of the first cathode active material layer, may be 50% by weight to 99% by weight. In some non-limiting embodiments, the content of the second cathode active material in the first cathode active material layer, based on the total weight of the first cathode active material layer, may be less than 50% by weight.

In some non-limiting embodiments, the content of the first cathode active material in the first cathode active material layer, based on the total weight of the first cathode active material layer, may be 73.62% by weight to 98.16% by weight, and the content of the second cathode active material in the first cathode active material layer, based on the total weight of the first cathode active material layer, may be less than 24.54% by weight.

In some non-limiting embodiments, the content of the first cathode active material in the second cathode active material layer, based on the total weight of the second cathode active material layer, may be less than 50% by weight. The content of the second cathode active material in the second cathode active material layer, based on the total weight of the second cathode active material layer, may be 50% by weight to 99% by weight.

In some non-limiting embodiments, the content of the first cathode active material in the second cathode active material layer, based on the total weight of the second cathode active material layer, may be less than 24.6% by weight, and the content of the second cathode active material in the second cathode active material layer, based on the total weight of the second cathode active material layer, may be 73.67% by weight to 98.4% by weight.

In some non-limiting embodiments, the content of the first conductive material in the first cathode active material layer, based on the total weight of the first cathode active material layer, may be 0.5% by weight to 1.5% by weight.

In some non-limiting embodiments, the content of the second conductive material in the second cathode active material layer, based on the total weight of the second cathode active material layer, may be 0.1% by weight to 0.8% by weight.

In some non-limiting embodiments, the ratio of the content of the first conductive material in the first cathode active material layer based on the total weight of the first cathode active material layer, to the content of the second conductive material in the second cathode active material layer based on the total weight of the second cathode active material layer, may be greater than 1 and less than or equal to 1.6.

In some non-limiting embodiments, the first conductive material and the second conductive material may each independently comprise at least one selected from the group consisting of single-walled carbon nanotubes (SWCNTs), multi-walled carbon nanotubes (MWCNTs), carbon black, Denka black and mixtures thereof.

In some non-limiting embodiments, the first cathode active material and the second cathode active material may each independently comprise a lithium metal oxide having a nickel content of 80 mol % to 99 mol %, based on the total molar amount of elements excluding lithium and oxygen.

A lithium secondary battery according to the present disclosure comprises: the cathode for a lithium secondary battery; and an anode disposed opposite to the cathode.

In some non-limiting embodiments, the anode may comprise an anode current collector and an anode active material layer disposed on one surface of the anode current collector and comprising a silicon-based active material, natural graphite, and/or artificial graphite.

In some non-limiting embodiments, the anode may comprise an anode current collector and a first anode active material layer and a second anode active material layer sequentially stacked on one surface of the anode current collector. The first anode active material layer and the second anode active material layer may each independently comprise a silicon-based active material, artificial graphite, and/or natural graphite. The content of the silicon-based active material in the first anode active material layer, based on the total weight of the first anode active material layer, may be less than the content of the silicon-based active material in the second anode active material layer, based on the total weight of the second anode active material layer.

In some non-limiting embodiments, the content of the artificial graphite in the first anode active material layer, based on the total weight of the first anode active material layer, may be less than the content of the artificial graphite in the second anode active material layer, based on the total weight of the second anode active material layer.

In some non-limiting embodiments, the content of the natural graphite in the first anode active material layer, based on the total weight of the first anode active material layer, may be greater than the content of the natural graphite in the second anode active material layer, based on the total weight of the second anode active material layer.

In some non-limiting embodiments, the artificial graphite may have a crystal orientation index of 1 to 10, as defined by Equation 1 below.

$$OI = {I}_{004} / {I}_{110} \qquad [ Equation 1 ]$$

In Equation 1, OI represents the crystal orientation index, I₀₀₄ represents the peak intensity of the (004) plane in the X-ray diffraction (XRD) pattern of the artificial graphite, and I₁₁₀ represents the peak intensity of the (110) plane in the XRD pattern of the artificial graphite.

The cathode for a lithium secondary battery according to some non-limiting embodiments of the present disclosure may enable a battery with high capacity retention even during repeated charge and discharge cycles. For example, a battery comprising the cathode for a lithium secondary battery may exhibit high capacity retention during repeated charge and discharge cycles at room temperature, and may exhibit improved capacity retention even during fast charge and discharge cycles.

Therefore, a battery with improved cycle life characteristics may be achieved.

In some non-limiting embodiments, the cathode for a lithium secondary battery of the present disclosure and the lithium secondary battery comprising the same may be widely applied in green technology fields, such as electric vehicles, battery charging stations, as well as solar power generation, wind power generation, and the like, which use the batteries. In some non-limiting embodiments, the cathode for a lithium secondary battery of the present disclosure and the lithium secondary battery comprising the same may be used in eco-friendly electric vehicles, hybrid vehicles, and the like, which are aimed at mitigating climate change by reducing air pollution and greenhouse gas emissions.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view of a cathode for a lithium secondary battery according to some non-limiting embodiments;

FIG. 2 is a plan view of a lithium secondary battery according to some non-limiting embodiments;

FIG. 3 is a schematic cross-sectional view of the lithium secondary battery according to some non-limiting embodiments; and

FIG. 4 is a graph showing the discharge capacity as a function of the number of cycles for the batteries of the examples and comparative examples.

### DETAILED DESCRIPTION

Unless the context clearly indicates otherwise, the singular forms of the terms used in the present disclosure may be interpreted as including the plural forms. As used herein, the singular form of “a”, “an”, and “the” include plural referents unless the context clearly states otherwise.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Unless indicated to the contrary, the numerical parameters set forth in the present disclosure are approximations that can vary depending upon the desired properties sought to be obtained by the present disclosure.

The numerical ranges used in the present specification includes all values within the ranges including the lower limit and the upper limit, increments logically derived from the form and spanning of a defined range, all double limited values, and all possible combinations of the upper limit and the lower limit of the numerical range defined in different forms. Unless otherwise defined in the present disclosure, values which may be outside of a numerical range due to experimental error or rounding off of a value are also included in the defined numerical range.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

The term “comprise” mentioned in the present disclosure is an open-ended description having a meaning equivalent to the term such as “include”, “is/are provided”, “contain”, or “have”, and does not exclude elements, materials, or processes which are not further listed.

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments of the disclosed subject matter. Hence, specific dimensions and other physical characteristics related to the embodiments disclosed herein are not to be considered as limiting.

No aspect, component, element, structure, act, step, function, instruction, and/or the like used herein should be construed as critical or essential unless explicitly described as such.

A cathode for a lithium secondary battery according to a non-limiting embodiment of the present disclosure comprises a cathode active material layer having a multi-layer structure. A lithium secondary battery according to a non-limiting embodiment of the present disclosure comprises the cathode.

Hereinafter, some non-limiting embodiments of the present disclosure will be described in detail with reference to the accompanying drawings. However, these embodiments are merely illustrative, and the present disclosure is not limited to the specific embodiments described as examples.

FIG. 1 is a schematic cross-sectional view of a cathode for a lithium secondary battery (hereinafter, also abbreviated as “cathode”) according to a non-limiting embodiment.

Referring to FIG. 1, a cathode 100 for a lithium secondary battery may comprise a cathode current collector 105 and a cathode active material layer disposed on at least one surface of the cathode current collector 105. The cathode active material layer may comprise a first cathode active material layer 111 and a second cathode active material layer 112, and the first cathode active material layer 111 and the second cathode active material layer 112 may be sequentially stacked on at least one surface of the cathode current collector 105.

According to some non-limiting embodiments, the first cathode active material layer 111 may be formed directly on the surface of the cathode current collector 105. The second cathode active material layer 112 may be formed directly on the upper surface of the first cathode active material layer 111 (e.g., the surface opposite to the contact surface with the cathode current collector).

In some non-limiting embodiments, the first cathode active material layer 111 comprises a first conductive material and a first cathode active material having a single-particle structure. In other non-limiting embodiments, the first cathode active material layer 111 comprises the first conductive material and a mixture of the first cathode active material and a second cathode active material having a secondary-particle structure.

In some non-limiting embodiments, the second cathode active material layer 112 comprises a second conductive material and the second cathode active material. In other non-limiting embodiments, the second cathode active material layer 112 comprises the second conductive material and a mixture of the first cathode active material and the second cathode active material.

In some non-limiting embodiments, the first cathode active material may comprise lithium metal oxide particles having a single-particle structure.

The term “single particle form” or “single particle structure” as used herein is used, for example, to exclude secondary particles formed by aggregation of a plurality of primary particles. For example, in the first cathode active material, a secondary-particle structure in which (e.g., greater than 10, 20 or more, 30 or more, 40 or more, 50 or more, etc.) of primary particles are assembled or agglomerated may be excluded.

The term “single particle form” or “single particle structure” as used herein does not exclude a structure in which 2 to 10 single particles are simply attached to or in contact with each other without aggregation to form a monolithic shape.

The second cathode active material may comprise lithium metal oxide particles having a secondary-particle structure. The term “secondary-particle structure” may refer to a structure distinct from the single-particle structure, in which a single particle comprises two or more single crystals.

For example, the single-particle structure and the secondary-particle structure may be identified based on ion images obtained by analyzing a particle cross-section using a focused ion beam (FIB). For example, when the particle has a secondary-particle structure, two or more single particles may be observed in the FIB analysis image due to differences in crystal orientation. For example, even if the particle appears as one particle in a scanning electron microscope (SEM) cross-sectional image, it may be observed as a particle composed of two or more crystals in the FIB analysis image.

In some non-limiting embodiments, the first cathode active material and the second cathode active material may each independently comprise a lithium metal oxide. In some non-limiting embodiments, the lithium metal oxide may comprise nickel, cobalt and/or manganese.

In some non-limiting embodiments, the first cathode active material and the second cathode active material may each independently comprise a lithium metal oxide having a nickel content of 80 mol % to 99 mol %, based on the total molar amount of elements excluding lithium and oxygen. In some non-limiting embodiments, the first cathode active material and the second cathode active material may each independently comprise a lithium metal oxide having a nickel content of 85 mol % to 95 mol %, based on the total molar amount of elements excluding lithium and oxygen.

In some non-limiting embodiments, the lithium metal oxide may comprise a layered structure represented by Formula 1 below.

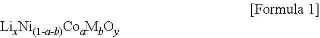

For example, in Formula 1, M may be at least one of Al, Zr, Ti, Cr, B, Mg, Mn, Ba, Si, Y, W or Sr, and x, y, a and b may each independently satisfy 0.9≤x≤1.2, 1.9≤y≤2.1, and 0≤a+b≤0.5.

In some non-limiting embodiments, a+b may satisfy 0<a+b≤0.4, 0<a+b≤0.3, 0<a+b≤0.2, 0<a+b≤0.17, 0<a+b≤0.15, 0<a+b≤0.12, or 0<a+b≤0.1.

In some non-limiting embodiments, a may satisfy 0<a≤0.1, 0<a≤0.08, or 0<a≤0.05.

As indicated in Formula 1, the lithium metal compound may comprise Ni among Ni, Co and M in the greatest amount or molar ratio. Ni may function as a metal substantially related to the output and/or capacity of the lithium secondary battery, and by comprising Ni in the greatest amount among transition metals, a high-capacity, high-output lithium secondary battery may be achieved.

When the content of Ni in the cathode active material or lithium metal oxide increases, the chemical stability such as the high-temperature storage stability of the secondary battery, may be relatively degraded. In addition, sufficient high-output and high-capacity characteristics resulting from the high Ni content may not be achieved due to surface damage on the cathode active material or side reactions with the electrolyte during repeated charge and discharge cycles.

In some non-limiting embodiments, the lithium metal oxide particles may further comprise a coating element and/or a doping element. For example, the coating element and/or doping element may comprise Al, Ti, Ba, Zr, Si, B, Mg, P, Sr, W, and/or La or an alloy or oxide thereof. In this case, a lithium secondary battery with improved cycle life characteristics may be achieved.

The first cathode active material and the second cathode active material may comprise lithium metal oxides having different metal compositions. For example, the first cathode active material may comprise a lithium metal oxide having a nickel content of 80 mol % to 99 mol %, based on the total molar amount of elements excluding lithium and oxygen, and the second cathode active material may comprise a lithium metal oxide having a nickel content different from that of the first cathode active material, based on the total molar amount of elements excluding lithium and oxygen.

In the first cathode active material layer 111, the content of the first cathode active material may be greater than that of the second cathode active material, based on the total weight of the first cathode active material layer. For example, the first cathode active material layer 111 may comprise no second cathode active material, or when it does comprise the second cathode active material, the content of the first cathode active material may be greater than that of the second cathode active material.

The first cathode active material having a single-particle structure may have a higher strength. In some non-limiting embodiments, the first cathode active material layer 111, which is adjacent to the cathode current collector 105 and receives electrons first during repeated battery charge and discharge cycles, may comprise a higher content of the first cathode active material than that of the second cathode active material. Accordingly, the cycle life characteristics of the cathode may be improved, and the capacity retention of the battery may be enhanced.

In some non-limiting embodiments, the content of the first cathode active material in the first cathode active material layer 111, based on the total weight of the first cathode active material layer, may be 50% by weight (“wt %”) to 99 wt %. In some non-limiting embodiments, the content of the first cathode active material in the first cathode active material layer, based on the total weight of the first cathode active material layer, may be 70 wt % to 99 wt %, 73.0 wt % to 98.20 wt %, or 73.62 wt % to 98.16 wt %.

In some non-limiting embodiments, the content of the second cathode active material in the first cathode active material layer 111, based on the total weight of the first cathode active material layer, may be less than 50 wt %. In some non-limiting embodiments, the content of the second cathode active material in the first cathode active material layer, based on the total weight of the first cathode active material layer, may be less than 25 wt %, or less than 24.54 wt %.

Within the above ranges, a cathode with further improved cycle life characteristics may be achieved.

In some non-limiting embodiments, the content of the second cathode active material in the second cathode active material layer 112 may be greater than or equal to that of the first cathode active material, based on the total weight of the second cathode active material layer 112. For example, the second cathode active material layer 112 may comprise no first cathode active material, or when it does comprise the first cathode active material, the content of the second cathode active material may be greater than or equal to that of the first cathode active material.

The second cathode active material having a secondary-particle structure may suppress an occurrence of cracks during repeated charge and discharge cycles. The second cathode active material layer 112, which is spaced apart from the cathode current collector 105 and comes into contact with the electrolyte first, may comprise a higher content of the second cathode active material than that of the first cathode active material. Accordingly, side reactions between the electrolyte and the cathode active material may be suppressed, and the cycle life characteristics of the cathode may be improved.

In some non-limiting embodiments, the content of the first cathode active material in the second cathode active material layer 112, based on the total weight of the second cathode active material layer, may be less than 50 wt %. In some non-limiting embodiments, the content of the first cathode active material in the second cathode active material layer, based on the total weight of the second cathode active material layer, may be 25 wt % or less, or less than 24.6 wt %.

In some non-limiting embodiments, the content of the second cathode active material in the second cathode active material layer 112, based on the total weight of the second cathode active material layer, may be 50 wt % to 99 wt %. In some non-limiting embodiments, the content of the second cathode active material in the second cathode active material layer, based on the total weight of the second cathode active material layer, may be 70 wt % to 99 wt %, 74 wt % to 98.5 wt %, or 73.67 wt % to 98.4 wt %.

Within the above ranges, a cathode with further improved cycle life characteristics may be achieved.

The content of the first conductive material in the first cathode active material layer 111, based on the total weight of the first cathode active material layer 111, may be greater than that of the second conductive material in the second cathode active material layer 112, based on the total weight of the second cathode active material layer 112. Accordingly, the electrical conductivity of the first cathode active material layer 111, which comprises a greater content of the first cathode active material having a single-particle structure, may be further enhanced, and the fast charge/discharge characteristics of the battery may be improved.

When the content of the first conductive material in the first cathode active material layer 111, based on the total weight of the first cathode active material layer 111, is less than that of the second conductive material in the second cathode active material layer 111, based on the total weight of the second cathode active material layer 112, the electrical conductivity of the first cathode active material layer 111, which is adjacent to the cathode current collector 105, may be reduced, resulting in a slower charge and discharge rate of the battery. Accordingly, the cycle life characteristics of the battery during repeated fast charging and discharging may be significantly degraded.

In some non-limiting embodiments, the content of the first conductive material in the first cathode active material layer 111, based on the total weight of the first cathode active material layer, may be 0.5 wt % to 1.5 wt %. In some non-limiting embodiments, the content of the first conductive material in the first cathode active material layer 111, based on the total weight of the first cathode active material layer, may be 0.55 wt % to 1 wt %, or 0.6 wt % to 0.9 wt %.

In some non-limiting embodiments, the content of the second conductive material in the second cathode active material layer, based on the total weight of the second cathode active material layer, may be 0.1 wt % to 0.8 wt %. In some non-limiting embodiments, the content of the second conductive material in the second cathode active material layer, based on the total weight of the second cathode active material layer, may be 0.2 wt % to 0.75 wt %, or 0.3 wt % to 0.7 wt %.

Within the above ranges, the electrical conductivity of the second cathode active material layer 112 may be sufficiently secured while further enhancing the electrical conductivity of the first cathode active material layer 111, thereby improving the cycle life characteristics of the battery during fast charging and discharging.

In some non-limiting embodiments, the ratio of the content of the first conductive material in the first cathode active material layer, based on the total weight of the first cathode active material layer, to the content of the second conductive material in the second cathode active material layer, based on the total weight of the second cathode active material layer, may be greater than 1 and less than or equal to 1.6. In some non-limiting embodiments, the ratio of the content of the first conductive material in the first cathode active material layer, based on the total weight of the first cathode active material layer, to the content of the second conductive material in the second cathode active material layer, based on the total weight of the second cathode active material layer, may be 1.2 to 1.5.

Within the above ranges, the cycle life characteristics of the battery during fast charging and discharging may be further improved.

In some non-limiting embodiments, the first conductive material and the second conductive material may each independently comprise single-walled carbon nanotubes (SWCNTs), multi-walled carbon nanotubes (MWCNTs), carbon black, Denka black and/or the like. In some non-limiting embodiments, the first conductive material and the second conductive material may comprise a CNT-based conductive material comprising single-walled carbon nanotubes (SWCNTs), multi-walled carbon nanotubes (MWCNTs), and/or the like, and/or a non-CNT-carbon-based conductive material comprising carbon black, Denka black and/or the like.

In some non-limiting embodiments, the content of the CNT-based conductive material, based on the total weight of the first conductive material, may be greater than that of the non-CNT-carbon-based conductive material, and the content of the CNT-based conductive material, based on the total weight of the second conductive material, may be greater than that of the non-CNT-carbon-based conductive material.

According to some non-limiting embodiments, the first cathode active material layer 111 and the second cathode active material layer 112 may each be formed by applying a cathode slurry comprising the first cathode active material and/or the second cathode active material and the first conductive material or the second conductive material to the surface of the cathode current collector, followed by drying and compressing.

For example, the first cathode active material and/or the second cathode active material and the conductive material may each be mixed and stirred with a binder and/or a conductive material dispersant in a solvent to prepare a first cathode slurry and a second cathode slurry, respectively. The first cathode slurry may be coated onto the cathode current collector 105, and then dried and roll-pressed to form the first cathode active material layer 111, while the second cathode slurry may be coated onto the first cathode active material layer 111, and then dried and roll-pressed to form the second cathode active material layer 112.

The cathode current collector 105 may comprise, for example, stainless steel, nickel, aluminum, titanium, and/or copper, or an alloy thereof, and alternately, may comprise aluminum or an aluminum alloy.

The binder may comprise, for example, an organic binder such as vinylidene fluoride-hexafluoropropylene copolymer (PVDF-co-HFP), polyvinylidene fluoride (PVDF), polyacrylonitrile, and/or polymethyl methacrylate, etc., or an aqueous binder such as styrene-butadiene rubber (SBR), and may be used together with a thickener such as carboxymethyl cellulose (CMC).

In some non-limiting embodiments, the content of the binder in the first cathode active material layer, based on the total weight of the first cathode active material layer, may be 0.1 wt % to 5 wt %. In some non-limiting embodiments, the content of the binder in the first cathode active material layer, based on the total weight of the first cathode active material layer, may be 0.1 wt % or more, 1 wt % or more, or 2 wt % or less, or 3 wt % or less.

In some non-limiting embodiments, the content of the binder in the second cathode active material layer, based on the total weight of the second cathode active material layer, may be 0.1 wt % to 5 wt %. In some non-limiting embodiments, the content of the binder in the second cathode active material layer, based on the total weight of the second cathode active material layer, may be 0.1 wt % or more, 1 wt % or more, or 2 wt % or less, or 3 wt % or less.

For example, a PVDF-based binder may be used as the cathode binder. In this case, the amount of the binder for forming the cathode active material layer may be reduced and the amount of the cathode active material may be relatively increased, thereby improving the output and capacity of the secondary battery.

In some non-limiting embodiments, the conductive material dispersant may comprise cellulose-based dispersant, hydrogenated nitrile butadiene rubber and/or the like.

In some non-limiting embodiments, the content of the conductive material dispersant in the first cathode active material layer, based on the total weight of the first cathode active material layer, may be 0.1 wt % to 2 wt %.

In some non-limiting embodiments, the content of the conductive material dispersant in the second cathode active material layer, based on the total weight of the second cathode active material layer, may be 0.1 wt % to 2 wt %.

The thicknesses of the first cathode active material layer 111 and the second cathode active material layer 112 are not particularly limited and, for example, may be the same.

A lithium secondary battery according to the present disclosure comprises the cathode for a lithium secondary battery and an anode disposed opposite to the cathode.

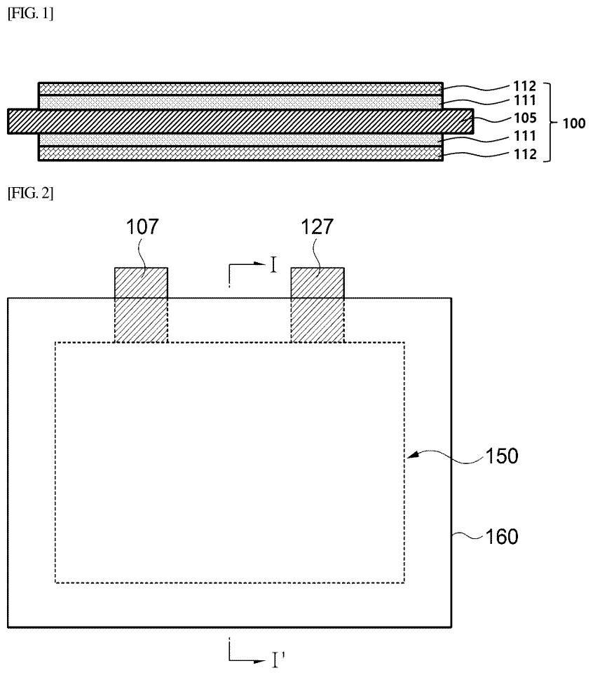

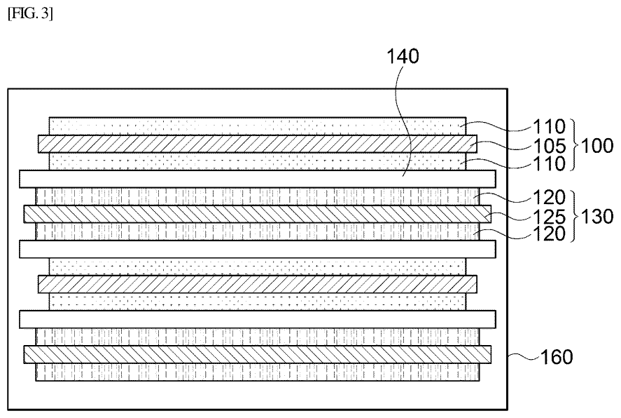

Hereinafter, the lithium secondary battery according to some non-limiting embodiments will be described in more detail with reference to the drawings. FIGS. 2 and 3 are schematic plan and cross-sectional views illustrating the lithium secondary battery according to some non-limiting embodiments, respectively. For example, FIG. 3 is a cross-sectional view taken along the line I-I′ of FIG. 2.

Referring to FIGS. 2 and 3, the lithium secondary battery may comprise an electrode assembly comprising the cathode 100, the anode 130, and a separation membrane 140 interposed between the cathode and the anode. The electrode assembly may be accommodated in a case 160 together with an electrolyte and may be impregnated with the electrolyte.

The cathode 100 comprises the cathode current collector 105 and a cathode active material layer 110, wherein the cathode active material layer 110 comprises a first cathode active material layer and a second cathode active material layer (not shown). The cathode 100 may be the same as described above.

In some non-limiting embodiments, the anode 130 may comprise an anode current collector 125 and an anode active material layer 120 disposed on one surface of the anode current collector 125. The anode active material layer 120 may comprise a silicon-based active material, natural graphite, and/or artificial graphite.

The anode current collector 125 may comprise, for example, stainless steel, nickel, aluminum, titanium, and/or copper, or an alloy thereof, and for example, may comprise copper or an alloy thereof.

The silicon-based active material may comprise, for example, a silicon-carbon composite compound such as silicon, silicon oxide (SiOx, 0<x<2), and/or silicon carbide (SIC).

In some non-limiting embodiments, the content of the silicon-based active material in the anode active material layer, based on the total weight of the anode active material layer, may be 1 wt % to 15 wt %. In some non-limiting embodiments, the content of the silicon-based active material in the anode active material layer, based on the total weight of the anode active material layer, may be 2 wt % to 10 wt %.

In some non-limiting embodiments, the anode may have a crystal orientation index of 1 to 10, as defined by Equation 1 below. In non-limiting embodiments, the anode may have a crystal orientation index of 2 to 7, as defined by Equation 1 below.

$$OI = {I}_{004} / {I}_{110} \qquad [ Equation 1 ]$$

In Equation 1, OI represents the crystal orientation index, I₀₀₄ represents the peak intensity of the (004) plane in the X-ray diffraction (XRD) pattern of the artificial graphite, and I₁₁₀ represents the peak intensity of the (110) plane in the XRD pattern of the artificial graphite.

The X-ray diffraction analysis may be performed using the equipment and under the conditions described below.
XRD (X-Ray Diffractometer) EMPYREAN
Maker: PANalytical
Anode material: Cu
K-Alpha1 wavelength: 1.540598 Å
Generator voltage: 45 kV
Tube current: 40 mA
Scan range: 10-120°
Scan step size: 0.0065°
Divergence slit: ¼°
Antiscatter slit: ½°

An XRD pattern may be obtained from the results of the XRD analysis. In the obtained XRD pattern, a peak corresponding to the (004) plane and a peak corresponding to the (110) plane may be observed. The intensity ratio of the two peaks may be calculated according to Equation 1, and the orientation index defined by Equation 1 may indicate the crystallinity of the crystalline carbon. Since the crystalline carbon has an orientation index of 10 or less, exposure of the anode active material (e.g., artificial graphite) may be suppressed, and cycle life characteristics may be further improved. Within this range, the anode active material may have high chemical and mechanical stability while increasing capacity and energy density.

In some non-limiting embodiments, the artificial graphite may comprise a first artificial graphite having a crystal orientation index of 1 to 5, as defined by Equation 1, and a second artificial graphite having a crystal orientation index of greater than 5 and less than 10, as defined by Equation 1.

In some non-limiting embodiments, the anode active material layer 120 may comprise a first anode active material layer and a second anode active material layer. The first anode active material layer and the second anode active material layer may be sequentially stacked on one surface of the anode current collector 125.

The first anode active material layer and the second anode active material layer may each independently comprise a silicon-based active material, artificial graphite, and/or natural graphite.

The content of the silicon-based active material in the first anode active material layer, based on the total weight of the first anode active material layer, may be less than that of the silicon-based active material in the second anode active material layer, based on the total weight of the second anode active material layer.

In some non-limiting embodiments, the content of the silicon-based active material in the first anode active material layer, based on the total weight of the first anode active material layer, may be 0.5 wt % to 5 wt %, and the content of the silicon-based active material in the second anode active material layer, based on the total weight of the second anode active material layer, may be 7 wt % to 15 wt %.

Within the above range, the second anode active material layer, which is spaced apart from the anode current collector 125, may comprise a higher content of silicon-based active material having a high volume change rate during charging and discharging. Accordingly, the stability of the anode during battery charge and discharge may be improved, and the cycle life characteristics of the battery may be enhanced.

In some non-limiting embodiments, the content of the artificial graphite in the first anode active material layer, based on the total weight of the first anode active material layer, may be less than that of the artificial graphite in the second anode active material layer, based on the total weight of the second anode active material layer. For example, the content of the artificial graphite in the first anode active material layer, based on the total weight of the first anode active material layer, may be 20 wt % to 50 wt %, and the content of the artificial graphite in the second anode active material layer, based on the total weight of the second anode active material layer, may be 55 wt % to 75 wt %.

In some non-limiting embodiments, the content of the natural graphite in the first anode active material layer, based on the total weight of the first anode active material layer, may be greater than that of the natural graphite in the second anode active material layer, based on the total weight of the second anode active material layer. For example, the content of the natural graphite in the first anode active material layer, based on the total weight of the first anode active material layer, may be 55 wt % to 75 wt %, and the content of the natural graphite in the second anode active material layer, based on the total weight of the second anode active material layer, may be 20 wt % to 50 wt %.

Within the above ranges, the stability of the anode may be further improved, and the cycle life characteristics of the battery may be further enhanced.

The anode 130 may comprise the anode active material layer 120 formed by coating an anode slurry onto the anode current collector 125. The anode slurry may comprise a silicon-based active material, artificial graphite, natural graphite, an anode binder and/or a conductive material.

The anode slurry may be prepared by mixing and stirring the anode active material with a binder, a conductive material and/or a dispersant in a solvent. The slurry may be coated onto the anode current collector 125, and then dried and roll-pressed to prepare the anode active material layer 120.

For example, the anode slurry may be prepared by mixing the anode active material with a solvent. The anode slurry may be applied to one surface of the anode current collector, followed by drying and roll-pressing to prepare the anode active material layer 120.

The coating process may be performed by any method such as gravure coating, slot die coating, simultaneous multilayer die coating, imprinting, doctor blade coating, dip coating, bar coating, casting, or the like, but is not limited thereto. The anode active material layer 120 may further comprise a binder and may optionally may further comprise a conductive material, a thickener and/or the like.

Non-limiting examples of the solvent may comprise water, purified water, deionized water, distilled water, ethanol, isopropanol, methanol, acetone, n-propanol, and/or t-butanol, etc.

In some non-limiting embodiments, the content of the solvent in the anode slurry may be 30 to 50 wt % based on the total weight of the anode slurry.

The above-described materials that can be used when manufacturing the cathode as the binder, conductive material and thickener may also be used for the anode.

In some non-limiting embodiments, a styrene-butadiene rubber (SBR)-based binder, carboxymethyl cellulose (CMC), polyacrylic acid-based binder, poly(3,4-ethylenedioxythiophene) (PEDOT)-based binder, and/or the like may be used as an anode binder.

In some non-limiting embodiments, the content of the binder in the first anode active material layer, based on the total weight of the first anode active material layer, may be 0.1 wt % to 5 wt %. In some non-limiting embodiments, the content of the binder in the first anode active material layer, based on the total weight of the first anode active material layer, may be 0.1 wt % or more, 2 wt % or more, or 3 wt % or less, or 4 wt % or less.

In some non-limiting embodiments, the content of the binder in the second anode active material layer, based on the total weight of the second anode active material layer, may be 0.1 wt % to 5 wt %. In some non-limiting embodiments, the content of the binder in the second anode active material layer, based on the total weight of the second anode active material layer, may be 0.1 wt % or more, 0.5 wt % or more, 1 wt % or more, or 2 wt % or less or 3 wt % or less.

In addition, the anode slurry may further comprise a dispersant for a conductive material (“conductive material dispersant”) to improve the dispersibility of the conductive material. For example, the conductive material dispersant may comprise cellulose-based dispersant, hydrogenated nitrile butadiene rubber (HNBR), and/or the like.

In some non-limiting embodiments, the content of the conductive material dispersant in the first anode active material layer, based on the total weight of the first anode active material layer, may be 0.1 wt % to 2 wt %.

In some non-limiting embodiments, the content of the conductive material dispersant in the second anode active material layer, based on the total weight of the second anode active material layer, may be 0.1 wt % to 2 wt %.

The separation membrane 140 may be interposed between the cathode 100 and the anode 130. The separation membrane 140 may comprise a porous polymer film made of a polyolefin polymer such as ethylene homopolymer, propylene homopolymer, ethylene/butene copolymer, ethylene/hexene copolymer, and/or ethylene/methacrylate copolymer. The separation membrane 140 may comprise a nonwoven fabric made of glass fibers having a high melting point, and/or polyethylene terephthalate fibers, etc.

In some non-limiting embodiments, the anode 130 may have an area (e.g., a contact area with the separation membrane 140) and/or volume greater than that of the cathode 100. Thereby, lithium ions generated from the cathode 100 may smoothly migrate to the anode 130 without being precipitated during the process, for example.

According to some non-limiting embodiments, an electrode cell is defined by the cathode 100, the anode 130 and the separation membrane 140, and a plurality of electrode cells may be stacked to form, for example, a jelly roll type or other type of electrode assembly 150. For example, the electrode assembly 150 may be formed by winding, stacking, or folding the separation membrane 140.

The electrode assembly 150 may be accommodated in the case 160 together with the electrolyte to define the lithium secondary battery. According to some non-limiting embodiments, a non-aqueous electrolyte may be used as the electrolyte.

The non-aqueous electrolyte may comprise a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃ (CF₂)₇SO₃⁻; CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, γ-butyrolactone, propylene sulfite, tetrahydrofuran, and/or the like may be used. These compounds may be used alone or in combination of two or more thereof.

As shown in FIG. 2, electrode tabs (cathode tabs and anode tabs) may be formed from the cathode current collector 105 and the anode current collector 125, each belonging to a respective electrode cell, and may extend to one side of the case 160. The electrode tabs may be welded together with the one side of the case 160 to form electrode leads (a cathode lead 107 and an anode lead 127) that extend from or are exposed to the outside of the case 160.

The lithium secondary battery may be manufactured, for example, in a cylindrical shape using a can, a prismatic shape, a pouch shape or a coin shape.

Hereinafter, non-limiting embodiments of the present disclosure will be further described with reference to specific experimental examples. However, the examples and comparative examples comprised in the experimental examples are provided merely for illustrative purposes of the present disclosure and are not intended to limit the scope of the disclosure. It will be apparent to those skilled in the art that various changes and modifications can be made within the scope and spirit of the present disclosure.

### Example 1

### (1) Preparation of Cathode

A lithium metal oxide having a single-particle structure (D50=5 μm) represented by LiNi₈₈Co₆Mn₆O₂, polyvinylidene fluoride (PVdF) as a binder, multi-walled carbon nanotubes (MWCNTs) as a conductive material, and a conductive material dispersant (hydrogenated nitrile butadiene rubber; HNBR) were mixed in a mass ratio of 98.16:1:0.7:0.14, and then mixed with N-methyl-2-pyrrolidone (NMP) as a solvent to prepare a first cathode slurry.

A lithium metal oxide having a secondary-particle structure (D50=13 μm) represented by LiNi₈₈Co₆Mn₆O₂, a binder (PVdF), a conductive material (multi-walled carbon nanotubes; MWCNTs), and a conductive material dispersant (hydrogenated nitrile butadiene rubber; HNBR) were mixed in a mass ratio of 98.40:1:0.5:0.1, and then mixed with N-methyl-2-pyrrolidone (NMP) as a solvent to prepare a second cathode slurry.

The first cathode slurry was uniformly applied to an aluminum foil (thickness: 12 μm), and then dried and roll-pressed to form a first cathode active material layer.

The second cathode slurry was uniformly applied to the first cathode active material layer, and then dried and roll-pressed to form a second cathode active material layer.

The total loading amounts of the first cathode active material layer and the second cathode active material layer were 21.30 g/cm², and the electrode density was 3.7 g/cm³.

### (2) Manufacture of Battery

Natural graphite, artificial graphite (degree of crystal orientation, i.e., crystal orientation index of 1 to 4), SiOx (0<x<2) as anode active materials, styrene-butadiene rubber as a binder, carboxymethyl cellulose as a thickener, single-walled carbon nanotubes (SWCNTs) as a conductive material, and a conductive material dispersant (cellulose-based dispersant) were mixed in a mass ratio of 44.55:44.55:8.00:1.50:1.20:0.08:0.12 and then dispersed in water to prepare an anode slurry. The anode slurry was coated on a copper foil having a thickness of 8 μm, and then dried and roll-pressed to fabricate an anode. The loading amount of the anode active material layer was 10.60 g/cm², and the electrode density was 1.64 g/cm³.

A film separator made of polyethylene (PE) with a thickness of 13 μm was stacked between the fabricated anode and the cathode, and a cell was assembled using a pouch having dimensions of 5 mm (thickness)×50 mm (width)×60 mm (length). Then, the non-aqueous electrolyte was injected into the pouch to manufacture a 2 Ah-class lithium secondary battery for an electric vehicle (EV). As the non-aqueous electrolyte, a solution in which LiPF₆ was dissolved at a concentration of 1 M in a mixed solvent containing ethylene carbonate and ethyl methyl carbonate in a volume ratio of 25:75 was used.

### Example 2

A lithium metal oxide having a single-particle structure (D50=5 μm) represented by LiNi₈₈Co₆Mn₆O₂, a lithium metal oxide having a secondary-particle structure (D50=13 μm) represented by LiNi₈₈Co₆Mn₆O₂, polyvinylidene fluoride (PVdF) as a binder, multi-walled carbon nanotubes (MWCNTs) as a conductive material, and a conductive material dispersant (hydrogenated nitrile butadiene rubber; HNBR) were mixed in a mass ratio of 73.62:24.54:1:0.7:0.14, and then mixed with N-methyl-2-pyrrolidone (NMP) as a solvent to prepare a first cathode slurry.

A lithium metal oxide having a single-particle structure (D50=5 μm) represented by LiNi₈₈Co₆Mn₆O₂, a lithium metal oxide having a secondary-particle structure (D50=13 μm) represented by LiNi₈₈Co₆Mn₆O₂, a binder (PVdF), a conductive material (multi-walled carbon nanotubes; MWCNTs), and a conductive material dispersant (hydrogenated nitrile butadiene rubber; HNBR) were mixed in a mass ratio of 24.60:73.80:1:0.5:0.1, and then mixed with N-methyl-2-pyrrolidone (NMP) as a solvent to prepare a second cathode slurry.

A cathode and a battery were manufactured in the same manner as in Example 1, except that the first cathode slurry and the second cathode slurry were prepared as described above.

### Example 3

A lithium metal oxide having a single-particle structure (D50=5 μm) represented by LiNi₈₈Co₆Mn₆O₂, a lithium metal oxide having a secondary-particle structure (D50=13 μm) represented by LiNi₈₈Co₆Mn₆O₂, polyvinylidene fluoride (PVdF) as a binder, multi-walled carbon nanotubes (MWCNTs) and Denka Black as conductive materials, and a conductive material dispersant (hydrogenated nitrile butadiene rubber; HNBR) were mixed in a mass ratio of 73.49:24.50:1:0.6:0.30:0.12, and then mixed with N-methyl-2-pyrrolidone (NMP) as a solvent to prepare a first cathode slurry.

A lithium metal oxide having a single-particle structure (D50=5 μm) represented by LiNi₈₈Co₆Mn₆O₂, a lithium metal oxide having a secondary-particle structure (D50=13 μm) represented by LiNi₈₈Co₆Mn₆O₂, polyvinylidene fluoride (PVdF) as a binder, multi-walled carbon nanotubes (MWCNTs) and carbon black as conductive materials, and a conductive material dispersant (HNBR) were mixed in a mass ratio of 24.60:73.80:1:0.4:0.30:0.08, and then mixed with N-methyl-2-pyrrolidone (NMP) as a solvent to prepare a second cathode slurry.

A cathode and a battery were manufactured in the same manner as in Example 1, except that the first cathode slurry and the second cathode slurry were prepared as described above.

### Example 4

A first anode slurry was prepared by mixing natural graphite, artificial graphite, and SiOx (0<x<2) as anode active materials, styrene-butadiene rubber as a binder, and carboxymethyl cellulose as a thickener in a mass ratio of 66.08:28.32:2.00:2.40:1.20, and then dispersing the mixture in water.

Natural graphite, artificial graphite, and SiOx (0<x<2) as anode active materials, styrene-butadiene rubber as a binder, carboxymethyl cellulose as a thickener, and single-walled carbon nanotubes (SWCNTs) and a conductive material dispersant (HNBR) were mixed in a mass ratio of 25.17:58.73:14.00:0.60:1.20:0.12:0.18 and then dispersed in water to prepare the second anode slurry.

The first anode slurry was coated onto an 8-μm-thick copper foil, followed by drying and rolling to produce an anode. The second anode slurry was uniformly applied to the first anode active material layer, dried, and then rolled to form a second anode active material layer.

The total loading of the first anode active material layer and second anode active material layer was 10.60 g/cm², and the electrode density was 1.64 g/cm³.

A battery was manufactured in the same manner as in Example 1, except that the anode was manufactured as described above.

### Example 5

A battery was manufactured in the same manner as in Example 1, except that 44.55 parts by weight of the first artificial graphite (crystal orientation index of 1 to 4) and 44.55 parts by weight of the second artificial graphite (crystal orientation index of 1 to 2.5) were used instead of natural graphite when preparing the anode slurry.

### Comparative Example 1

A lithium metal oxide having a single-particle structure (D50=5 μm) represented by LiNi₈₈Co₆Mn₆O₂, polyvinylidene fluoride (PVdF) as a binder, multi-walled carbon nanotubes (MWCNTs) as a conductive material, and a conductive material dispersant (HNBR) were mixed in a mass ratio of 98.40:1:0.5:0.1, and then mixed with N-methyl-2-pyrrolidone (NMP) as a solvent to prepare a first cathode slurry.

A lithium metal oxide having a secondary-particle structure (D50=13 μm) represented by LiNi₈₈Co₆Mn₆O₂, a binder (PVdF), a conductive material (multi-walled carbon nanotubes; MWCNTs), and a conductive material dispersant (HNBR) were mixed in a mass ratio of 98.16:1:0.7:0.14, and then mixed with N-methyl-2-pyrrolidone (NMP) as a solvent to prepare a second cathode slurry.

A cathode and a battery were manufactured in the same manner as in Example 1, except that the first cathode slurry and the second cathode slurry were prepared as described above.

### Comparative Example 2

A cathode and a battery were manufactured in the same manner as in Example 1, except that a lithium metal oxide having a single-particle structure (D50=5 μm) represented by LiNi₈₈Co₆Mn₆O₂ was used instead of the lithium metal oxide having a secondary-particle structure during the preparation of the second cathode slurry.

### Comparative Example 3

A lithium metal oxide having a single-particle structure (D50=5 μm) represented by LiNi₈₈Co₆Mn₆O₂, polyvinylidene fluoride (PVdF) as a binder, multi-walled carbon nanotubes (MWCNTs) as a conductive material, and a conductive material dispersant (HNBR) were mixed in a mass ratio of 98.28:1:0.6:0.12, and then mixed with N-methyl-2-pyrrolidone (NMP) as a solvent to prepare a first cathode slurry.

A lithium metal oxide having a secondary-particle structure (D50=13 μm) represented by LiNi₈₈Co₆Mn₆O₂, a binder (PVdF), a conductive material (multi-walled carbon nanotubes; MWCNTs), and a conductive material dispersant (hydrogenated nitrile butadiene rubber; HNBR) were mixed in a mass ratio of 98.28:1:0.6:0.12, and then mixed with N-methyl-2-pyrrolidone (NMP) as a solvent to prepare a second cathode slurry.

A cathode and a battery were manufactured in the same manner as in Example 1, except that the first cathode slurry and the second cathode slurry were prepared as described above.

The cathode and anode compositions of the examples and comparative examples are shown in Tables 1 and 2 below.

TABLE 1

| | | Cathode composition (mass ratio) | | | | |
|---|---|---|---|---|---|---|
| | | | | Conductive | | Conductive |
| | | Single | Secondary | material | | material |
| | | particle | particle | C-1 | C-2 | dispersant |
| Example 1 | Second active | — | 98.4 | 0.5 | — | 0.1 |
| | material layer | | | | | |
| | First active | 98.16 | — | 0.7 | — | 0.14 |
| | material layer | | | | | |
| | Average | 49.08 | 49.2 | 0.6 | — | 0.12 |
| Example 2 | Second active | 24.6 | 73.8 | 0.5 | — | 0.1 |
| | material layer | | | | | |
| | First active | 73.62 | 24.54 | 0.7 | — | 0.14 |
| | material layer | | | | | |
| | Average | 49.11 | 49.17 | 0.6 | — | 0.12 |
| Example 3 | Second active | 24.56 | 73.67 | 0.4 | 0.3 | 0.08 |
| | material layer | | | | | |
| | First active | 73.49 | 24.5 | 0.6 | 0.3 | 0.12 |
| | material layer | | | | | |
| | Average | 49.02 | 49.08 | 0.5 | 0.3 | 0.1 |
| Example 4 | Second active | 24.6 | 73.8 | 0.5 | — | 0.1 |
| | material layer | | | | | |
| | First active | 73.62 | 24.54 | 0.7 | — | 0.14 |
| | material layer | | | | | |
| | Average | 49.11 | 49.17 | 0.6 | — | 0.12 |
| Example 5 | Second active | — | 98.4 | 0.5 | — | 0.1 |
| | material layer | | | | | |
| | First active | 98.16 | — | 0.7 | — | 0.14 |
| | material layer | | | | | |
| | Average | 49.08 | 49.2 | 0.6 | — | 0.12 |
| Comparative | Second active | — | 98.16 | 0.7 | — | 0.14 |
| Example 1 | material layer | | | | | |
| | First active | 98.4 | — | 0.5 | — | 0.1 |
| | material layer | | | | | |
| | Average | 49.2 | 49.08 | 0.6 | — | 0.12 |
| Comparative | Second active | 98.4 | — | 0.5 | — | 0.1 |
| Example 2 | material layer | | | | | |
| | First active | 98.16 | — | 0.7 | — | 0.14 |
| | material layer | | | | | |
| | Average | 98.28 | — | 0.6 | — | 0.12 |
| Comparative | Second active | — | 98.28 | 0.6 | — | 0.12 |
| Example 3 | material layer | | | | | |
| | First active | 98.28 | — | 0.6 | — | 0.12 |
| | material layer | | | | | |
| | Average | 49.14 | 49.14 | 0.6 | — | 0.12 |

TABLE 2

| | | Anode composition (mass ratio) | | | | | | |
|---|---|---|---|---|---|---|---|---|
| | | | | | | | | Conductive |
| | | Natural | Artificial | | | | | material |
| | | graphite | graphite | SiOx | CMC | SBR | C-3 | dispersant |
| Example 1 | | 44.55 | 44.55 | 8 | 1.2 | 1.5 | 0.08 | 0.12 |
| Example 2 | | 44.55 | 44.55 | 8 | 1.2 | 1.5 | 0.08 | 0.12 |
| Example 3 | | 44.55 | 44.55 | 8 | 1.2 | 1.5 | 0.08 | 0.12 |
| Example 4 | Second | 25.17 | 58.73 | 14 | 1.2 | 0.6 | 0.12 | 0.18 |
| | active | | | | | | | |
| | material | | | | | | | |
| | layer | | | | | | | |
| | First | 66.08 | 28.32 | 2 | 1.2 | 2.4 | — | — |
| | active | | | | | | | |
| | material | | | | | | | |
| | layer | | | | | | | |
| | Average | 45.63 | 43.53 | 8 | 1.2 | 1.5 | 0.06 | 0.09 |

| | | | | | | | |
|---|---|---|---|---|---|---|---|
| Example 5 | — | 89.1* | 8 | 1.2 | 1.5 | 0.08 | 0.12 |
| Comparative | 44.55 | 44.55 | 8 | 1.2 | 1.5 | 0.08 | 0.12 |
| Example 1 | | | | | | | |
| Comparative | 44.55 | 44.55 | 8 | 1.2 | 1.5 | 0.08 | 0.12 |
| Example 2 | | | | | | | |
| Comparative | 44.55 | 44.55 | 8 | 1.2 | 1.5 | 0.08 | 0.12 |
| Example 3 | | | | | | | |

*In the anode composition of Example 5, 44.55 parts by weight of a first artificial graphite having a crystal orientation index of 1 to 4 and 44.55 parts by weight of a second artificial graphite having a crystal orientation index of 1 to 2.5 were used.

* In the anode composition of Example 5, 44.55 parts by weight of a first artificial graphite having a crystal orientation index of 1 to 4 and 44.55 parts by weight of a second artificial graphite having a crystal orientation index of 1 to 2.5 were used.
C-1: Multi-walled carbon nanotubes (MWCNTs)
C-2: Carbon black
C-3: Single-walled carbon nanotubes (SWCNTs)

### Experimental Example 1: Evaluation of Room-Temperature Cycle Life Characteristics

The lithium secondary batteries of the examples and comparative examples were each charged (CC-CV 0.3 C, 4.2 V, 0.05 C cut-off) and discharged (CC 0.5 C, 2.5 V cut-off) for 1,000 cycles at room temperature (25° C.), the discharge capacity was then measured according to the number of cycles. The discharge capacities at the 600th, 800th, and 1,000th cycles were measured, and each was divided by the initial discharge capacity to calculate the capacity retention. The results are shown in Table 3 below. When a sharp drop in capacity occurs, it is indicated by “-.”

### Experimental Example 2: Evaluation of Fast-Charge Cycle Life Characteristics

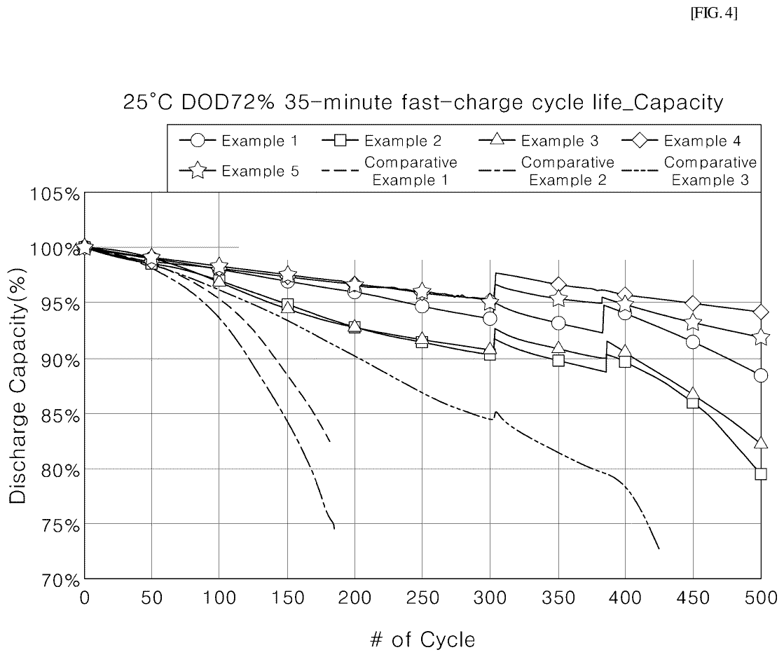

Fast charging and discharging (0.33 C, CC cut-off) were performed on the batteries of the examples and comparative examples at room temperature (25° C.) for 20 minutes within a SOC range of 10% to 80% over 500 cycles. The discharge capacity was measured according to the number of cycles, and the results are shown in FIG. 4. In addition, the discharge capacities at the 300th, 400th, and 500th cycles were divided by the initial discharge capacity to calculate the capacity retention. The results are shown in Table 3 below. When a sharp drop in capacity occurs, it is indicated by “-.”

TABLE 3

| | Room-temperature life | | | Fast-charge cycle life | | |
|---|---|---|---|---|---|---|
| | characteristics (%) | | | characteristics (%) | | |
| | 600 | 800 | 1,000 | 300 | 400 | 500 |
| | cycles | cycles | cycles | cycles | cycles | cycles |
| Example 1 | 94.2 | 91.9 | 89.1 | 93.5 | 94 | 88.4 |
| Example 2 | 94.1 | 91.2 | 86.7 | 90.2 | 89.5 | 79.5 |
| Example 3 | 94.6 | 92.3 | 89.3 | 90.7 | 90.4 | 82.3 |
| Example 4 | 94.7 | 92.4 | 89.8 | 95.1 | 95.7 | 94.2 |
| Example 5 | 94.8 | 92.8 | 90.0 | 95.1 | 94.8 | 91.8 |
| Comparative | 92.5 | — | — | — | — | — |
| Example 1 | | | | | | |
| Comparative | 89.7 | — | — | — | — | — |
| Example 2 | | | | | | |
| Comparative | 92.8 | 88.0 | — | 84.4 | 78.3 | — |
| Example 3 | | | | | | |

Referring to Table 3 and FIG. 4, the batteries of the Examples exhibited a high capacity retention of 85% or more after 1,000 charge and discharge cycles at room temperature, and a capacity retention of 75% or more after 500 repeated fast charge and discharge cycles.

On the other hand, the batteries of the Comparative Examples exhibited a sharp drop in capacity retention after about 800 charge and discharge cycles at room temperature, and the capacity retention sharply dropped after about 180 repeated fast charge and discharge cycles, thereby degrading the cycle life characteristics.

The contents described above are merely examples of applying the principles of the present disclosure, and other configurations may be further comprised without departing from the scope of the present disclosure. For example, while embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. Additionally, it is to be understood that the present disclosure contemplates that, to the extent possible, one or more features of any embodiment can be combined with one or more features of any other embodiment.

### DESCRIPTION OF REFERENCE NUMERALS

100: Cathode
105: Cathode current collector
107: Cathode lead
110: Cathode active material layer
111: First cathode active material layer
112: Second cathode active material layer
120: Anode active material layer
125: Anode current collector
127: Anode lead
130: Anode
140: Separation membrane
150: Electrode assembly
160: Case

What is claimed is:

1. A cathode for a lithium secondary battery comprising:
a cathode current collector; and
a first cathode active material layer and a second cathode active material layer sequentially stacked on one surface of the cathode current collector,
wherein the first cathode active material layer comprises a first conductive material and either a first cathode active material having a single-particle structure, or a mixture of the first cathode active material and a second cathode active material having a secondary-particle structure,
wherein the second cathode active material layer comprises a second conductive material and either the second cathode active material, or a mixture of the first cathode active material and the second cathode active material,
wherein, in the first cathode active material layer, the content of the first cathode active material is greater than the content of the second cathode active material, based on the total weight of the first cathode active material layer,
wherein, in the second cathode active material layer, the content of the second cathode active material is greater than or equal to the content of the first cathode active material, based on the total weight of the second cathode active material layer, and
wherein the content of the first conductive material in the first cathode active material layer, based on the total weight of the first cathode active material layer, is greater than the content of the second conductive material in the second cathode active material layer, based on the total weight of the second cathode active material layer.

2. The cathode for a lithium secondary battery according to claim 1, wherein the content of the first cathode active material in the first cathode active material layer, based on the total weight of the first cathode active material layer, is 50% by weight to 99% by weight, and the content of the second cathode active material in the first cathode active material layer, based on the total weight of the first cathode active material layer, is less than 50% by weight.

3. The cathode for a lithium secondary battery according to claim 1, wherein the content of the first cathode active material in the first cathode active material layer, based on the total weight of the first cathode active material layer, is 73.62% by weight to 98.16% by weight, and the content of the second cathode active material in the first cathode active material layer, based on the total weight of the first cathode active material layer, is less than 24.54% by weight.

4. The cathode for a lithium secondary battery according to claim 1, wherein the content of the first cathode active material in the second cathode active material layer, based on the total weight of the second cathode active material layer, is less than 50% by weight, and the content of the second cathode active material in the second cathode active material layer, based on the total weight of the second cathode active material layer, is 50% by weight to 99% by weight.

5. The cathode for a lithium secondary battery according to claim 1, wherein the content of the first cathode active material in the second cathode active material layer, based on the total weight of the second cathode active material layer, is less than 24.6% by weight, and the content of the second cathode active material in the second cathode active material layer, based on the total weight of the second cathode active material layer, is 73.67% by weight to 98.4% by weight.

6. The cathode for a lithium secondary battery according to claim 1, wherein the content of the first conductive material in the first cathode active material, based on the total weight of the first cathode active material layer, is 0.5% by weight to 1.5% by weight.

7. The cathode for a lithium secondary battery according to claim 1, wherein the content of the second conductive material in the second cathode active material layer, based on the total weight of the second cathode active material layer, is 0.1% by weight to 0.8% by weight.

8. The cathode for a lithium secondary battery according to claim 1, wherein the ratio of the content of the first conductive material in the first cathode active material layer based on the total weight of the first cathode active material layer, to the content of the second conductive material in the second cathode active material layer based on the total weight of the second cathode active material layer, is greater than 1 and less than or equal to 1.6.

9. The cathode for a lithium secondary battery according to claim 1, wherein the first conductive material and the second conductive material each independently comprise at least one selected from the group consisting of single-walled carbon nanotubes (SWCNTs), multi-walled carbon nanotubes (MWCNTs), carbon black, Denka black, and mixtures thereof.

10. The cathode for a lithium secondary battery according to claim 1, wherein the first cathode active material and the second cathode active material each independently comprise a lithium metal oxide having a nickel content of 80 mol % to 99 mol %, based on the total molar amount of elements excluding lithium and oxygen.

11. A lithium secondary battery comprising:
the cathode for a lithium secondary battery according to claim 1; and
an anode disposed opposite to the cathode.

12. The lithium secondary battery according to claim 11, wherein the anode comprises an anode current collector and an anode active material layer disposed on one surface of the anode current collector and comprising a silicon-based active material, natural graphite, and/or artificial graphite.

13. The lithium secondary battery according to claim 11, wherein the anode comprises an anode current collector and a first anode active material layer and a second anode active material layer sequentially stacked on one surface of the anode current collector,
wherein the first anode active material layer and the second anode active material layer each independently comprise a silicon-based active material, artificial graphite, and/or natural graphite, and
wherein the content of the silicon-based active material in the first anode active material layer, based on the total weight of the first anode active material layer, is less than the content of the silicon-based active material in the second anode active material layer, based on the total weight of the second anode active material layer.

14. The lithium secondary battery according to claim 13, wherein the content of the artificial graphite in the first anode active material layer, based on the total weight of the first anode active material layer, is less than the content of the artificial graphite in the second anode active material layer, based on the total weight of the second anode active material layer.

15. The lithium secondary battery according to claim 13, wherein the content of the natural graphite in the first anode active material layer, based on the total weight of the first anode active material layer, is greater than the content of the natural graphite in the second anode active material layer, based on the total weight of the second anode active material layer.

16. The lithium secondary battery according to claim 12, wherein the artificial graphite has a crystal orientation index of 1 to 10, as defined by Equation 1 below:
$$OI = {I}_{004} / {I}_{110} \qquad [ Equation 1 ]$$
(in Equation 1, OI represents the crystal orientation index, I₀₀₄ represents the peak intensity of the (004) plane in the X-ray diffraction (XRD) pattern of the artificial graphite, and I₁₁₀ represents the peak intensity of the (110) plane in the XRD pattern of the artificial graphite).

17. The cathode for a lithium secondary battery according to claim 1, wherein the first cathode active material and the second cathode active material each independently comprise a lithium metal oxide,
wherein the lithium metal oxide comprises a layered structure represented by Formula 1: 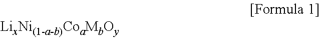
wherein M is at least one of Al, Zr, Ti, Cr, B, Mg, Mn, Ba, Si, Y, W or Sr, and x, y, a and b satisfy 0.9≤x≤1.2, 1.9≤y≤2.1, and 0≤a+b≤0.5.

18. The cathode for a lithium secondary battery according to claim 1, wherein the first cathode active material and/or the second cathode active material each independently comprise lithium metal oxide particles comprising a coating element and/or a doping element.

19. The cathode for a lithium secondary battery according to claim 1, wherein a content of the first conductive material in the first cathode active material layer, based on the total weight of the first cathode active material layer, is 0.5 wt % to 1.5 wt %.

20. The cathode for a lithium secondary battery according to claim 1, wherein a content of the second conductive material in the second cathode active material layer, based on the total weight of the second cathode active material layer, is 0.1 wt % to 0.8 wt %.
